(19) United States
(12) Patent Application Publication
(10) Pub. No.: US 2026/0134082 A1
(43) Pub. Date: May 14, 2026

(54) FRAUD DETECTION AND DATA CORRELATIONS THROUGH LARGE-SCALE GRAPH CLUSTERING OF GRAPH TRANSFORMATIONS AND EMBEDDINGS

(71) Applicant: PAYPAL, INC., San Jose, CA (US)

(72) Inventors: Chi Liu, Shanghai (CN); Xin Chen, Shanghai (CN); Haoran Liu, Shanghai (CN)

(21) Appl. No.: 18/946,731

(22) Filed: Nov. 13, 2024

(51) Int. Cl. G06F 21/50; G06N 20/00

(52) U.S. Cl. CPC G06F 21/50; G06N 20/00

(57) ABSTRACT

Computer security improvements relating to fraud detection and data correlations through large-scale graph clustering of graph transformations and embeddings are disclosed. A service provider may utilize a framework having computing operations for detecting fraud and other malicious or suspicious activities by groups of accounts and fraudsters. In this regard, the service provider may transform relationship graphs of account networks and relationships between accounts and account data captured in the nodes and edges of such graphs. The service provider may merge nodes that edges connecting to other nodes of a certain type of account data, while other types of account data and nodes may not be merged. Edges may also be merged and weighted, and the resulting transformed graph may undergo graph embedding to generate vectors that may be clustered using an AI clustering algorithm. The clusters may then be used for AI model training and inferencing.

### TECHNICAL FIELD

The present application generally relates to artificial intelligence (AI) systems for fraud and security threat detection, and more particularly to machine learning (ML) clustering of accounts through graph transformations and embeddings of the accounts' relationship graphs.

### BACKGROUND

As hackers and other malicious entities become more sophisticated, they may perform different computing attacks and other malicious conduct more often and with increased effectiveness. Such conduct may attempt to gain access to sensitive identification and/or authentication information, or otherwise compromise computer security credentials, which can lead to fraud and data breaches. To address this, service providers may utilize security threat detection systems to identify suspicious behavior and malicious activities and then take appropriate actions. Fraud, account takeovers (ATOs), money laundering schemes, and the like are constantly changing, and new strategies, vulnerabilities, or other techniques by which fraud can be conducted are constantly being identified by bad actors.

As such, intelligent systems for automating fraud detection and prevention require more advanced and evolving techniques and solutions. Thus, security threat detection systems may be more complex to address more sophisticated computing attacks, and deploying a solution in a live production computing environment may take considerable time and resources. The longer time it takes to deploy a new or updated solution, the more potential there is for fraud and security systems to be compromised. As such, there is a need for improved, faster, and more accurate detection of fraudulent and/or suspicious relationships between accounts to more precisely identify fraud and fraudulent groups of users or accounts in or near real-time.

### BRIEF DESCRIPTION OF THE DRAWINGS

FIG. 1 is a block diagram of a networked system suitable for implementing the processes described herein, according to an embodiment;

FIGS. 2A-2C are exemplary diagrams of relationship graph transformations for more efficient and accurate graph embedding generation usable for ML clustering models and algorithms, according to an embodiment;

FIGS. 3A-3B are exemplary diagrams of executable processes for generating and clustering graph embeddings from relationship graphs of linked account data, according to an embodiment;

FIG. 4 is a flowchart for fraud detection and data correlations through large-scale graph clustering of graph transformations and embeddings, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for fraud detection and data correlations through large-scale graph clustering of graph transformations and embeddings. Systems suitable for practicing methods of the present disclosure are also provided. Note that while various examples, structures, techniques, etc. may be described with respect to a service provider in this specification, these structures, techniques, etc. are generalizable and are applicable to any entity that implements security systems and defenses for fraud detection using machine learning (ML) models, according to various embodiments.

In an entity's (e.g., service provider's) systems, such as online platforms and systems that allow users to interact with, use, and request data processing, the entity may provide a computing architecture that may face different types of fraud, ATOs, money laundering, and other malicious and/or unlawful conduct from multiple sources over a network. These sources may correspond to multiple fraudulent actors and/or their devices, as well as accounts of other unknowing and/or unwitting participants (e.g., accounts that have been taken over by fraudulent actors), who may act in unison and/or in a planned scheme together to engage in fraudulent, malicious, and/or illegitimate actions or operations. To better detect fraud, accounts used by these participants may be linked based on shared activities, behaviors, information, and/or other account data that may be generated, detected, and/or received during use of the accounts.

To reduce risk, fraud, and loss, online transaction processors and other online service providers may implement a security and threat detection system, which may utilize fraud detection processes. Conventionally, risk detection systems and models may analyze behaviors of users, accounts, and the like at the time of engagement with a particular system, platform, application, website, or the like. For example, a risk model may analyze a transaction based on transaction data, participants, and the like and the time that a transaction is being conducted, which offers limited insight into the parties and potentially fraudulent activity. For example, more recently, fraudsters cooperate closely with each other in collaborative crimes and malicious activities. However, it may be difficult to identify transaction-level fraud in real-time, near real-time, and/or after a short time after the fraud occurs based merely on this data. For example, transactions with a new or verified account, including ATOs of legitimate accounts, may appear valid and allowed to process the transactions, but may actually be used for fraudulent activities and linked to several other fraudulent accounts and actors.

In this regard, an online transaction processor may implement one or more systems, executable pipelines, frameworks, and/or operations, as discussed herein, to cluster account relationship graphs and other links between account data (e.g., shared information, behaviors or activities, etc.) that are linked to fraudulent accounts and/or actors. Clustering of accounts may be performed using one or more ML algorithms and/or techniques and may be used to train an ML clustering model that may make predictions or inferences based on cluster membership and/or correlations between accounts. Clustering may be done to provide fraud detection responses and other risk assessment operations automatically, thereby providing real-time and/or near real-time detection of activities and behaviors by fraudsters without requiring manual input and/or efforts to generate such detections. This may provide rapid, automatic, and adaptive reactionary and real-time fraud detection by leveraging this account behavior clustering into behavior sequences.

In order for service providers to carry out fraud detection and identify these teams for fraudsters, a “seller” risk team may collect information of seller account hoping to find closely related sellers, but this often results in a huge network of connections. Given a seller account network, where a vertex represents the seller account and an edge represents the connection relationship between different sellers, such as the same mobile phone number, the same credit card, etc., a relationship graph may be generated that represents the accounts links to account data of different types, such as contact information, a financial account number, a user identity number, a virtual identifier, a device identifier, or a domain identifier associated with the contact information or the financial account number. Relationship graphs may be used to correlate different objects and resources in order to identify how accounts are related to account data, as well as how that account data is related to other account data. For example, an account may correspond to a node and may be linked by an edge to a phone number, representing a connection between the account and the phone number (e.g., the phone number is listed for the account or has been previously used with, to identify, or to engage in account services for the account).

Relationship graphs may be made for accounts of a service provider system. In this regard, a user may wish to process a transaction, which may require use of an account to effectuate a payment to another user or a transfer of currency, including fiat currency, digital or virtual currency, cryptocurrency, and the like. A user may pay for one or more transactions using a digital wallet or other account with an online service provider or transaction processor (e.g., PayPal®). An account may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The account and/or digital wallet may be loaded with currency or currency may otherwise be added to the account or digital wallet. The application or website of the service provider, such as PayPal® or other online payment provider, may provide payments and the other transaction processing services via the account and/or digital wallet.

Once the account and/or digital wallet of the user is established, the user may utilize the account via one or more computing devices, such as a personal computer, tablet computer, mobile smart phone, or the like. The accounts may then be used for different online activities, interactions, and the like. As such, accounts may be associated with account data, which may be used to generate relationship graphs for the accounts. Relationship graphs or social graphs may correspond to graphs in two or three-dimensional space that represent relationships or connections as edges between different graph objects, or nodes, for the accounts and account data. Graph objects may include nodes for the account and account data, where each node is associated with an account and/or account data (including a type of account data) that defines the corresponding object that may be identified by the transaction processor or other service provider. The connections of an object to different objects may show relationships between objects, which may include “hard” links or “soft” links based on the type of account data related to the account. Hard linked account data may correspond to connections where the two pieces of data are linked with a strong correlation or association, and/or may strongly identify a user, device, entity, or identity/identification. Soft linked account data may correspond to connections where the data may not have a strong correlation or association with a particular user, device, entity, or identity/identification, or may be weakly associated with identifying a particular account or user and could be associated with multiple accounts or users. For example, hard linked account data may include contact information, a financial account number, or a user identity number, while soft linked account data may include a virtual identifier, a device identifier, or a domain identifier associated with the contact information or the financial account number.

A service provider may provide a system and processor to process large relationship graphs and other graphs representing connections between users, entities, financial accounts, communication accounts/identifiers/addresses, and other user data. However, processing of these graphs to identify fraud may be difficult. These graphs may be large in scale, such as tens of millions of nodes and billions of edges. They also may be heterogeneous, where different kinds of links between entities may have a different weight of link that is difficult to measure. With a sparse graph or graph portion, there may be many connected components with less than 10 nodes in a sparse graph. As such, with unsupervised clustering, lack of prior knowledge of clustering with these types of graphs may cause difficulties when determining the number of clusters, the size of the density of the clusters, and other hyperparameters of the ML model. As such, identifying fraudulent accounts, ATOs, and the like may be difficult with these graphs.

To process these graphs, graph transformations may first be utilized to merge graph nodes and connections in a weighted manner that represents the underlying data but enables graph embeddings to be generated in a more efficient manner. Using the transformed graphs, the embeddings may be generated with reduced features or dimensionality so that more accurate, efficient, and predictive clustering may be performed without overfitting or the like that may occur with very tightly and closely trained ML models. Graphs of these accounts may be generated based on account data, where nodes represent accounts and account data, and edges may represent links or connections between the users or other data, such as connections based on interactions (e.g., sales, communications, shared activities, etc.), possession, use, or the like. For example, a user that is linked to a particular financial instrument, such as a credit card and/or a debit card, may be shown through a connection between those nodes in the relationship graph. These edges, objects, and nodes may include a weight representing a strength of the connection, and the strength may be rated as “hard” or “soft” based on the type of the correlation or connection, as well as knowledge or weight assigned to the connection. For example, hard type of correlations may include correlations based on a link to a phone number, credit card, email, national identity card or NID (e.g., a driver's license, passport, etc.), bank account, or the like. Soft type linking may be based on a virtual identity/identifier or VID, a device ID, a supercookie or other tracking cookie, an IP address, and email domain, a bank branch, or the like.

Nodes for account data may also include account behaviors that may correspond to those computing operations and/or activities executed by a computing device with or using the account in response to one or more user interface commands input to the computing device (e.g., by a user when using the account via a web browser or dedicated software application). In this regard, behaviors may correspond to inputs, commands, application programming interface (API) calls or requests, navigations, and the like that may be executed using a computing device when accessing and/or utilizing the account with the service provider. A graph database may serve as a centralized resource to provide data for relationship graphs between users to different systems. A graph database may include APIs that allow for API calls to be exchanged with the service provider's computing system in order to allow for querying and retrieval of graphs or the data necessary to build and/or determine graphs.

The graph database may be specifically selected and implemented to allow for a query language tailored to graph queries. Once a graph is retrieved and/or generated, the nodes with corresponding hard and/or soft links may be identified. A graph transformation process may then implement a process by which the connected components of hard linking may be merged into new nodes to obtain a transformed graph. As such, an operation may scan, parse, and/or traverse (e.g., through a graph traversal operation that processes data for each node and edge in an ordered manner for a traversal along pathways made from the nodes and edges) a relationship graph. The parsing may identify hard connections between accounts and/or account data, and merge their corresponding nodes for the connected components of the hard links. For example, a phone number that may be linked to three accounts may have the nodes for the phone number and all three accounts merged into a single node. Where a node may be hard linked to multiple other nodes, all of these nodes may collectively be merged.

As a result, the nodes in the relationship may be greatly condensed and reduced in number and size. However, soft links may still exist between nodes, and may have existed between various nodes that were merged. As such, the graph transformation process may further merge the edges for soft links of the nodes that were merged, so that the resulting edges left in the relationship graph represent merged soft linked connections between accounts and/or account data. When merging soft linked connections, the links may be weighted based on the weight of the previous connections and edges, as well as the number and/or type of soft linked data and/or connection. Thus, the resulting transformed graph from a relationship graph may include a set of nodes from the merged nodes and other nodes that did not include hard linked connections and thus were not merged, with corresponding connections that may be weighted from previously set weights and/or newly determined weights from merged soft linked connections.

The system may then generate and learn a node embedding vector of a transformed graph using a large-scale information network embedding (LINE) approach and algorithm. Embedding may correspond to a process by which input data is converted to an embedding, or a vector or other mathematical representation of the input data. The embedding may have a dimensionality representing the features or other input variables that may be converted to the embedding, and the embedding may allow for representation of the input data in a vector space (e.g., a space of n or higher dimensionality for n dimensions of the embedding and input features). A graph embedding may therefore convert graph nodes and their connections to vectors, where the vectors encode information of the graph including nodes and their connections (as well as strength of connections), thereby allowing machine learning algorithms and models to operate on the embeddings. The graph embeddings of the transformed relationship graphs may therefore allow for fast comparisons in the vector space.

Once the embeddings have been generated of multiple relationship graphs, clustering of the node embedding vectors may be performed using hierarchical density-based spatial clustering of applications with noise (HDBSCAN or hierarchical DBSCAN). However, other supervised and/or unsupervised ML clustering algorithms may also be used for training an ML clustering model and clustering data. Clustering may include representing the embeddings in a graph or vector space and generating clusters from the representations based on an ML clustering algorithm or technique. Each cluster may have a cluster size, participants or members (e.g., membership), and/or other cluster parameter (e.g., similarity score, centroid, cluster size, cluster size as a function of distance from the cluster centroid, etc.). Further, a number of clusters or other hyperparameter of the ML clustering process may be set or tuned during ML clustering. Thereafter, the clusters may be used to train and establish an ML fraud detection system that may make inferences and/or correlations based on similarities to clusters and/or cluster parameters (e.g., centroid, membership, etc.). By identifying those clusters exhibiting fraudulent behavior and/or linked to fraudulent accounts/actors, other accounts likely to be used for fraudulent behavior may be identified in real-time and/or quickly using the ML clustering model trained as described herein.

As such, the service provider, such as an online transaction processor, may utilize a graph transformation, encoding, and clustering framework that allows for training of a clustering system that allows for correlating users and/or accounts with those indicating fraud and/or having similar behaviors and data for fraud identification. This allows the service provider to implement an end-to-end process for clustering using embeddings of graph transformations of merged hard linked objects with aggregations and merging of soft links. The process may merge connected components into a new node for those that are linked by hard links. For this, the process may split the graph by hard linking and soft linking and compute the connected components for the graph of hard linking. The connected components may be merged into a new node for hard links, and the soft links may be merged together to show combined soft links, which may be weighted, such as based on the number of soft links combined. This allows for clustering through computations of embeddings, and thereafter clustering of those embeddings, in a more efficient manner with smaller graphs and more condensed and optimized data. As such, relationship graphs with many soft links and nodes may be better represented in a more efficient manner and data structure, which allows for faster and more efficient clustering while maintaining accuracy and avoiding overfitting or other ML issues during inferencing.

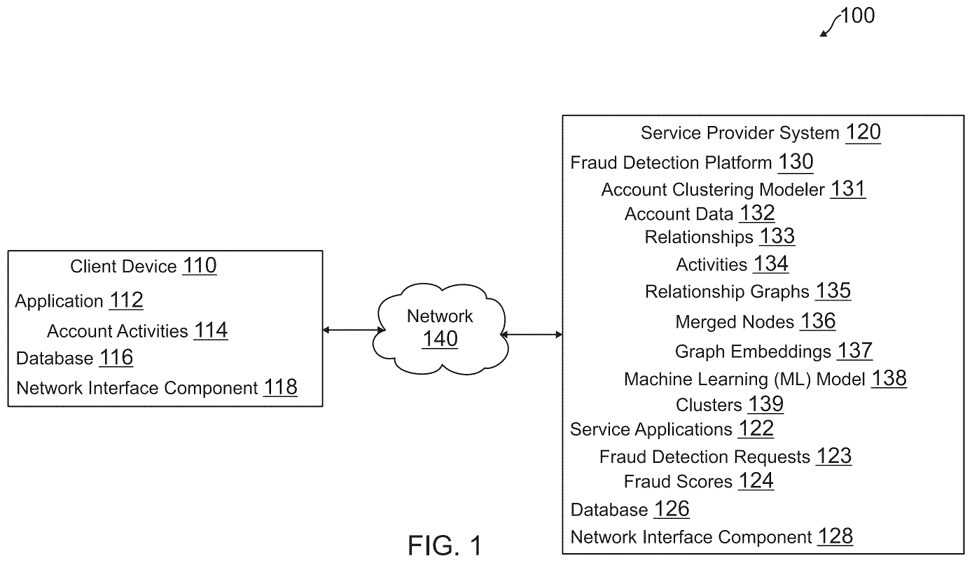

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., IOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110 and a service provider system 120 in communication over a network 140. Client device 110 may be utilized by a user, such as a customer of service provider system 120, to engage in activities with other computing devices, servers, and systems over network 140, including those associated with an account. Service provider system 120 may provide various data, operations, and other functions over network 140 to provide services to merchants, users, and their computing systems and devices, which may include electronic transaction processing. In this regard, client device 110 may utilize an account and/or provide account data, which may be processed by service provider system 120 to identify fraud and other illegal, illicit, or unauthorized activities being performed with other accounts and/or users linked through relationship graphs, as discussed herein.

Client device 110 and service provider system 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device of a customer, fraudulent actor, and/or other user associated with service provider system 120. Client device 110 may utilize appropriate hardware and software configured for wired and/or wireless communication with service provider system 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user over network 140, which may include accessing and/or interacting with service provider system 120, for example, to process a transaction, payment, or transfer. In this regard, application 112 may correspond to specialized software utilized by a user of client device 110 that may be used to access a website or user interface provided by service provider system 120 to perform actions or operations, which may include those associated with an account. As such, application 112 may be used to provide, engage in, and/or transmit information for account activities 114. Account activities 114 may be associated with one or more accounts accessed and/or used through application 112 and may therefore be linked to an account.

Account activities 114 may include information associated with actions, behaviors, interactions, and the like performed with or using an account, and may include contact information, a financial account number, a user identity number, a virtual identifier, a device identifier, or a domain identifier. Account activities 114 may be used to generate, determine, and/or store account data, which may be processed by service provider system 120, as discussed herein. When using application 112, a bad actor may utilize application 112 and/or engage in account activities 114 to conduct fraud via the account, which may be linked to other bad actors and/or fraudulent accounts. As such, service provider system 120 may process account activities 114 for identification of fraud through linking the account used through application 112 and/or account activities to other fraudulent accounts using an ML clustering model trained as discussed herein. However, where client device 110 is not used by a bad actor, a valid user may also use application 112 and engage in transaction processing, and account activities 114 may be nonfraudulent and authorized using the same or similar ML clustering model.

To provide account activities 114, application 112 may interact with service provider system 120, such as through interfacing with service applications 122 through one or more application programming interfaces (APIs) and/or API calls that may be exchanged including requests and responses. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information (e.g., a website for a merchant), presenting the website information to the user, and/or communicating information to the website including navigating between webpages to login to accounts, process transactions, and/or otherwise utilize computing services.

However, in other embodiments, application 112 may include a dedicated software application of service provider system 120 or other entity (e.g., a merchant) resident on client device 110 (e.g., a mobile application on a mobile device), which may be configured to view and utilize data via user interfaces (e.g., applications interfaces displayable by a graphical user interface (GUI) associated with application 112) and request execution of computing operations when utilizing accounts with service provider system 120. Thus, application 112 may provide one or more of user interfaces, for example, via GUIs presented using an output display device of client device 110, to enable the user associated with client device 110 to utilize computing services, platforms, and applications of service provider server with accounts, which may request execution of computing operations through user interface commands and other user inputs.

Application 112 may provide transaction processing, such as through a user interface enabling the user to enter and/or view a transaction for processing. This may be based on a transaction generated by application 112 using a service provider platform or website, merchant marketplace, or by performing peer-to-peer transfers and payments via service provider system 120 in conjunction with another account and/or computing device, which may link accounts and/or account data in a network of users. As such, fraudulent users may be identified from their shared networks using the processes described herein for clustering of transformed graphs from account relationship graphs. Application 112 may access accounts and view and/or utilize account information, user financial information, and/or transaction histories. In some embodiments, different services may be provided by service provider system 120 via application 112 including social networking, messaging, media posting or sharing, microblogging, data browsing and searching, online shopping, and other services available through service provider system 120. Thus, application 112 may also correspond to different service applications and the like that are associated with service provider system 120.

Client device 110 may further include or have access to database 116, which may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider system 120.

Client device 110 includes at least one network interface component 118 adapted to communicate with service provider system 120 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider system 120 of FIG. 1 includes a fraud detection platform 130, service applications 122, a database 126, and a network interface component 128. Service applications 122 and/or fraud detection platform 130 may correspond to executable processes, platforms, applications, and/or associated content and data with corresponding hardware. In other embodiments, service provider system 120 may include additional or different applications, platforms, and modules having corresponding hardware and/or software as required by their corresponding embodiments.

Fraud detection platform 130 may correspond to one or more processes to execute modules and associated specialized hardware of service provider system 120 to provide an account clustering modeler 131 that may be utilized for modeling ML clustering models based on transformations of relationship graphs for accounts and account data. In some embodiments, fraud detection platform 130 may correspond to specialized hardware and/or software used by an internal agent, employee, chatbot, or other user and/or automation involved in performing clustering of accounts and/or training ML clustering models. However, in other embodiments, an external user, such as a partner service, customer entity, or the like may request account clustering and/or ML model training and inferencing using the processes described herein, for example, to utilize fraud detection services provided by service provider system 120.

Initially, fraud detection platform 130 may execute account clustering modeler 131 and/or receive account data 132, such as account activities 114 from client device 110, for purposes of ML model training, such as by clustering accounts according to their relationship graphs. However, to provide more efficient and optimized ML model training and account clustering according to their relationship graphs, a more accurate and efficient representation of the relationship graphs may be required. As such, on receipt of account data 132, account clustering modeler 131 may parse account data 132 to determine the accounts and corresponding account data that are linked or connected between accounts and/or between the different types of account data. For example, a phone number may be shared between or associated with multiple accounts and may also be linked to an email address, which also may be shared or associated with the same or different accounts. As such, relationships 133 may include data representing the links or connections between accounts and account data, such as by identifying the account and/or account data and a shared connection, as well as information about the connection (e.g., how and when the connection was made, such as using a phone number to verify an account, storing a financial instrument as a payment means for an account, etc.).

Each one of relationships 133 may also include or have a corresponding “hard” or “soft” link or connection type, which may be based on the type of account data that is connected between the accounts. For example, a phone number, credit card, email, national identity card or NID (e.g., a driver's license, passport, etc.), bank account, etc., may correspond to “hard” linked data and connections, while soft linked account data may include a virtual identifier, a device identifier, or a domain identifier associated with the contact information or the financial account number. Activities 134 may be used to designate certain ones of relationships 133, such as how the account data was utilized, stored, or affiliated with the accounts, as well as the behaviors or uses of the account data. As such, activities 133 may correspond to account activities 114 performed by client device 110 and may also be used to weigh certain ones of relationships.

Using account data 132, account clustering modeler 131 may access, generate, and/or determine relationship graphs 135. Relationship graphs 135 may correspond to a graph, represented in a two or three-dimensional space, of relationships 133, such as a social graph or other visual representation of relationships 133 having accounts and account data (each represented as the corresponding data and type of data) as nodes, and connections between the accounts and/or account data as edges. As such, relationship graphs 135 may correspond to a diagram of how accounts and account data are connected. In order to more efficiently process relationship graphs 135, account clustering modeler 131 may execute a graph transformation process by which nodes, or accounts/account data, having hard links to other nodes are merged into the same singular node, which represents all of those nodes hard linked together. This transformation process may generate merged nodes 136. When generating merged nodes 136, relationship graphs 135 may be converted to transformed graphs having merged nodes 136 from the transformation process. Merged nodes 136 are then represented in the transformed graphs, where the remaining connections represent soft links or accounts/data having those ones of relationships 135 classified as soft instead of hard. Since multiple soft linked connections of relationships 133 may be merged into a single connection and/or representation of the multiple connections, the resulting connection/representation may be weighted according to their soft links, number of soft links, previous weights, and/or merged account/data types.

Thereafter, graph embeddings 137 may be generated, which may be used for training an ML model 138, such as by generating clusters 139 that may be used for inferencing and predicting behaviors, patterns, activities, and/or affiliations (e.g., relationships to others) of accounts. As such, ML model 138 may be used to infer or predict whether an account and/or activity of the account is engaging in fraud or likely fraudulent based on their relationships to other accounts and/or account data. Graph embeddings 137 may be generated using a graph embedding process, such as large-scale information network embedding (LINE) or the like, which may embed information networks, such as relationship graphs 135 and/or transformed graphs having merged nodes 136 from relationship graphs 135, into lower dimensional vector spaces for clustering and/or other ML operations (e.g., by reducing large networks of high dimensionality to vectors in a lower dimensional vector space). Graph embeddings 137 may correspond to vectors in a vector space that may allow for training of ML model 138 by clustering graph embeddings 137 into clusters 139.

Thus, graph embeddings 137 may be used for ML model training, such as using a supervised or unsupervised ML clustering algorithm. For example, a data scientists and other model training teams may train ML model 138 and/or other ML models for fraud detection platform 130. Although ML model 138 is described as a ML clustering model, fraud detection platform 130 may include and/or train other types of ML models including neural networks (NNs) and deep NNs (DNNs), large language models (LLMs) or other generative Als, tree-based and other types of ML models, the like. As such, graph embeddings 137 may also be used as input and/or feature data for features when training and/or inferencing using other types of ML models. With ML clustering algorithms, such as an unsupervised ML clustering algorithm, an algorithm may be selected based on a cluster parameter, a cluster stability, or a performance metric.

For training an ML clustering model for ML model 138, clusters 139 may be generated using training data, such as graph embeddings 137 of relationships graphs, which may further be associated with information and/or metadata for the corresponding accounts including annotations or identification of fraudsters and the like for identification of particular cluster attributes, behaviors, activities, identification or the like for clusters 139. An ML clustering algorithm may cluster graph embeddings 137 in the training data according to their vectors in the vector space. As such, the ML clustering algorithm and/or cluster generator may be invoked and/or executed to cluster graph embeddings 137 according to their features (e.g., vectors), as well as cluster hyperparameters or settings, such as an initial number of clusters, cluster size and/or distance from a cluster centroid, cluster centroid selection for a cluster, and the like. An ML clustering algorithm and/or technique may be applied to determine a number of clusters, cluster membership or representation, cluster centroids, cluster size and/or distance from a cluster centroid, and the like. Clusters 139 may be generated and used to train and configure ML model 138 based on the corresponding shared characteristics, behaviors, identifications, activities, and/or other information or metadata for the relationship graphs represented by graph embeddings 137. With other types of ML models, layers, branches, neurons, and the like may be trained using a corresponding training algorithm and/or technique with graph embeddings 137.

Layers, branches, clusters, or the like may be trained for inferencing and predictive tasks or inferencing tasks associated with shared cluster information, such as by predicting an account having a relationship graph that is correlated with a cluster may exhibit the same or similar information as that cluster. As such, if an account's relationship graph associates that account with known fraudster accounts based on clusters 139, the account may be suspicious, flagged for review, or prevented from engaging in certain actions. ML model 138 may be deployed with service applications 122 for ML model inferencing during runtime and/or with corresponding computing services. For example, ML model 138 may be used for risk assessment and/or fraud detection/prevention, such as by detecting if an account may be linked to or exhibit behavior similar to fraudulent accounts and therefore should be prevented from engaging in certain uses of service applications 122 and/or investigated.

In this regard, a fraud detection score or assessment may be generated based on a fraud detection request by comparing the relationship graph to the clustered graphs, and a response may be generated that indicates the score or assessment and the clustered graphs. The response may further indicate account behaviors of the accounts corresponding to the relationship graphs in the clusters. For example, where account behaviors of accounts in a cluster may be associated with fraud and/or fraudulent transactions or activities, then the relationship graph compared and correlated to that cluster may also be associated with the similar fraud and a fraud score may be used to determine if the account may be authorized to perform an action (e.g., process a transaction) or access a computing service/data. The score may be associated with a threshold similarity, and therefore if the score meets or exceeds a threshold similarity, the account may be considered sufficiently similar to the cluster of accounts such that the account behaviors by that cluster may be inferred on the account for fraud detection and risk assessment.

Service applications 122 may correspond to one or more processes to execute modules and associated specialized hardware of service provider system 120 to process a transaction and/or provide other computing services to users. For example, service applications 122 may be used to process payments and other services to one or more users, merchants, and/or other entities for transactions, where use of those services, applications, websites, data, and the like may include use of ML model 138 for predictive inferencing and/or other outputs. In this regard, users, including merchants and other entities, as well as customers and individual users, may establish a digital account for engagement with the products and services of service provider system 120. For example, the account may be used to send and receive payments, including those payments that may be enabled through a website and/or application of users, merchants, and other transaction participants. A payment account may be accessed and/or used through a browser application and/or dedicated payment application executed by a device, such a payment and/or digital wallet application. Service applications 122 may process payments and may provide transaction histories to client device 110 and/or another user's device or account for transaction authorization, approval, or denial of the transaction for placement and/or release of the funds, including transfer of the funds between accounts based on compliance investigations.

In further embodiments, service applications 122 may provide different computing services to users and entities, including social networking, microblogging, media sharing, messaging, business and consumer platforms, etc. Use of the computing services may require use of certain AI systems, such as those for fraud detection and/or risk assessment. In this regard, service applications 122 may be integrated with fraud detection platform 130 for use and/or deployment of ML model 138 once trained. For example, accounts may utilize service applications 122 to engage in different account activities, such as electronic transaction processing requests. These may generate fraud detection requests 123, which may include account and/or account data, or identifiers for access and/or retrieval of such data. Relationship graphs for accounts associated with fraud detection requests 123 may be determined, transformed, and converted to a graph embedding using the aforementioned processes for generation of graph embeddings 137. Thereafter, fraud scores 124 may be determined for fraud detection requests 123 by comparing the graph embeddings to clusters 139 and/or performing other ML inferencing using ML model 138. Fraud scores 124 may indicate a similarity to certain ones of clusters 139 and/or their corresponding members or centroid, and a threshold similarity or fraud score may be used to determine whether fraud scores 124 meet or exceed a level, or the threshold, of potential for fraud to be actionable.

Service applications 122 may also provide additional features to service provider system 120. For example, service applications 122 may include security applications for implementing server-side security features, programmatic client applications for interfacing with appropriate APIs over network 140, or other types of applications. Service applications 122 may contain software programs, executable by a processor, including one or more GUIs and the like, configured to provide an interface to the user when accessing service provider system 120, where the user or other users may interact with the GUI to view and communicate information more easily. Service applications 122 may include additional connection and/or communication applications, which may be utilized to communicate information to over network 140.

Additionally, service provider system 120 includes or may access database 126. Database 126 may store various identifiers associated with client device 110, as well as account data, including payment instruments, financial information, account balances, and authentication credentials, as well as transaction processing histories and data for processed transactions. Database 126 may include information for accounts including account data 132, which may be processed for generating relationship graphs 135 and/or graph embeddings 137, which may also be stored by database 126. Although database 126 is shown as residing on service provider system 120 as a database, in other embodiments, other types of data storage and components may be used including cloud computing storage nodes, remote data stores and database systems, distributed database systems over network 140 and/or of a computing system associated with service provider system 120, and the like.

Service provider system 120 may include at least one network interface component 128 adapted to communicate client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

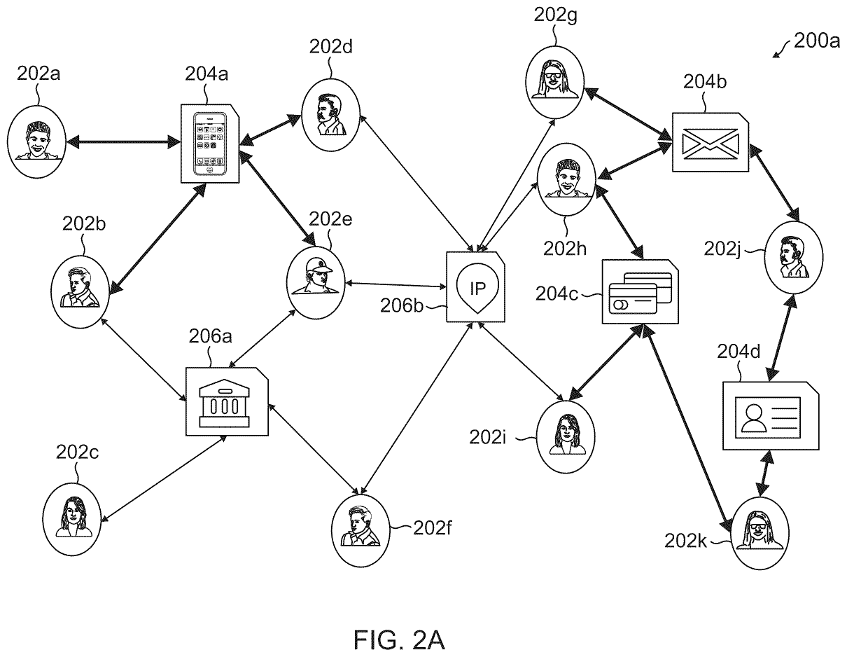

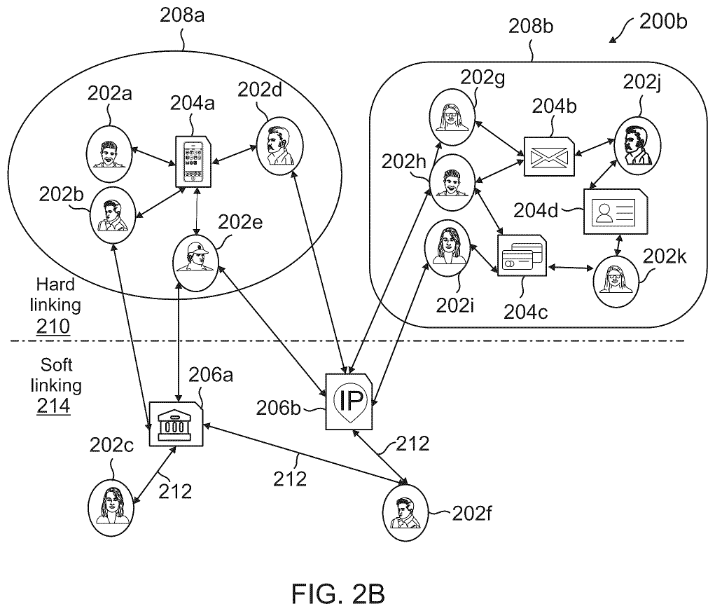

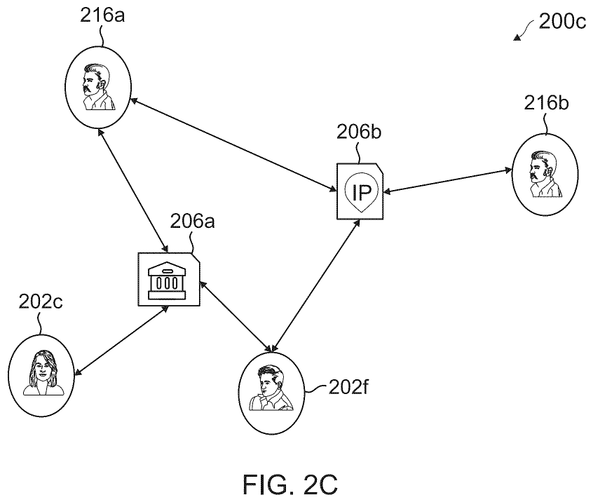

FIGS. 2A-2C are exemplary diagrams 200a-200c of relationship graph transformations for more efficient and accurate graph embedding generation usable for ML clustering models and algorithms, according to an embodiment. Diagrams 200a-200c may correspond to a representation of one of relationship graphs 135 when processed by account clustering modeler 131 of fraud detection platform 130 for service provider system 120, discussed in reference to system 100 of FIG. 1. In this regard, the relationship graph from diagrams 200a-200c may undergo a graph transformation based on node merging, such as when relationship graphs 135 are parsed and processed to generate merged nodes 136, so that graph embeddings 137 or similar vector representation(s) of the relationship graph may be created for training of ML model 138 or similar ML modeling operations of service provider system 120.

In diagram 200a of FIG. 2A, each of accounts 202a-k may be associated with account data, such as data provided or stored with the account (e.g., personal information and PII, financial information, contact identifiers, etc.), online interactions, and/or data that may be detected during the course of use of the account. For example, accounts 202a-k may be used by one or more users, which may set and/or establish account data during setup, onboarding, and/or use of the accounts. Further, the users may utilize accounts 202a-k to engage with other users and/or perform online interactions with users, computing services, and/or different computing platforms. During such account uses, the users may provide account data, such as a phone number or contact/financial information, or interactions may generate data, such as a use of an IP address when a device utilizes the account over a network or when the account interacts with another account, device, or contact address/identifier.

In order to provide graph transformations that convert the relationship graph shown in diagram 200a to a more manageable size for computational efficiency and accurate embedding generation (e.g., to reduce the dimensionality and/or size of the graph by reducing the number of nodes and connections), a graph transformation process may identify and assign each account data to a type of account data. This allows for a determination and assignment of connections between account data to one of two connection types, a first “hard” linked account data 204a-d and “hard” connection type and a second “soft” linked account data 206a-b and “soft” connection type. Hard connections may correspond to those connections where the two pieces of data that are linked have a strong correlation or association, and/or may strongly identify a user, device, entity, or identity/identification. Soft connections may correspond to those connections where the data may not have a strong correlation or association with a particular user, device, entity, or identity/identification, or may be weakly associated with identifying a particular account or user and could be associated with multiple accounts or users.

For hard linked account data 204a-d, the type of account data may correspond to a phone number, credit card, email, national identity card or NID (e.g., a driver's license, passport, etc.), bank account, or other data that may be assigned such a label depending on the clustering and/or inferencing task for the ML model and cluster identification. Types of soft linked account data 206a-b may include a virtual identity/identifier or VID, a device ID, a supercookie, an IP address, and email domain, a bank branch, or other type of account data that may be assigned such a label for the same or similar clustering and/or inferencing task. As such, in diagram 200a, the bold arrows designate hard connections between hard linked account data 204a-d, and the lighter arrows designate soft connections between soft linked account data 206a-b. To reduce graph size and complexity, nodes for hard linked account data 204a-d, and after merging, remaining soft connections between soft linked account data 206a-b may be merged, as well as weighted if desired, as shown in diagrams 200b-c.

Referring now to diagrams 200b and 200c together, in diagram 200b, node groupings 208a-b for hard linked account data 204a-d are shown, with the remaining soft connections for soft linked account data 206a-b. In this regard, node groupings 208a-b may be merged into single nodes, as shown in diagram 200c. For example, node grouping 208a shows accounts 202a, 202b, 202d, and 202e connected to hard linked account data 204a, such as a cell phone number or mobile device identifier. This may be set when a user registers a contact number or information for accounts 202a, 202b, 202d, and 202e, or when the user uses the cell phone number or mobile device with the account, such as by calling and engaging in assistance for the account using the number, requesting a text message is sent to the number, or uses an application on the mobile device with the account. Merging of the nodes for accounts 202a, 202b, 202d, and 202e may be performed under the assumption that sharing hard linked account data 204a indicates that the accounts are strongly linked and/or correlated, such as by belonging to the same user or group of users (e.g., a family, group of friends, or, in the context of fraud detection, the same fraudster or group of fraudsters).

In a similar manner for node grouping 200b, accounts 202g-k are connected to hard linked account data 204b-d. However, accounts 202g-k share links to multiple ones of hard linked account data 202b-d, and as such, form a sub-network (of the account network shown in diagrams 200a and 200b) that includes accounts 202g-k and hard linked account data 202d-b. The hard connections between accounts 202g-k and hard linked account data 202d-b tie accounts 202g-k to each other through mutual hard connections to the same account data. As such, node grouping 200b may be entirely merged to a single node for simplicity and efficiency during embedding generation and cluster based on the correlations of hard linked account data 204b-d and the strong likelihood or assumption that accounts 202g-k belong to the same user or group of users, which may include fraudsters.

However, soft linked account data 206a and 206b are linked to accounts 202c and 202f, which do not have other hard connections to account data. In this regard, soft linked account data 206a and 206b may not trigger the presumption. As such, node merging for linked accounts, of hard linked account data 204a-d because the data may have less correlations, and therefore less confidence, that the data would be shared by the same user or group of users, or that the data may be shared by many accounts and/or users and thus not correlate two or more accounts and/or users. Therefore, when the graph transformation process is applied to node groupings 208a-b, nodes for accounts 202c and 202f may not be merged with any other nodes to retain their corresponding representations in the account network and relationship graph for and during graph embedding.

As such, once the graph transformation process has identified node groupings 208a-b in diagram 200b, a node merging processing may be performed to merge the nodes for the accounts in node groupings 208a-b, which results in merged nodes 216a-b in diagram 200c. Merged nodes 216a-b may therefore condense and transform the data for each of the individual nodes representing accounts 202a-b, 202d-e, and 202g-k and hard linked account data 204a-d into a single node representing such data. Merged nodes 216a-b may greatly reduce the size and complexity of the relationship graph while retaining the information and initial assumptions of account correlations and interactivity for fraud detection purposes. The transformed relationship graph, or transformed graph, represented in diagram 200c retains soft linked account data 206a-b and accounts 202c and 202f for encoding and embedding purposes in a graph embedding, or other vector, so that ML clustering algorithms may be applied to learn and inference behaviors, patterns, and/or correlations to other accounts, account data, and/or fraudsters based on links between accounts and their data. As such, a graph embedding may be generated from the transformed graph in diagram 200c, as discussed below.

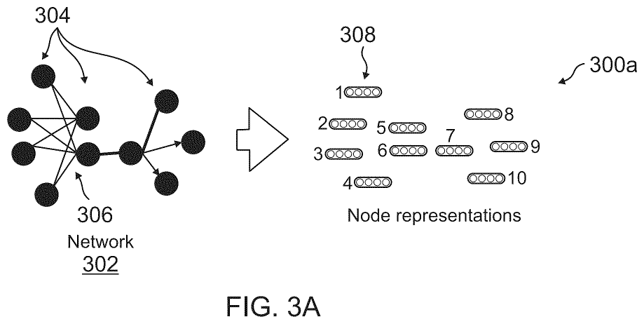

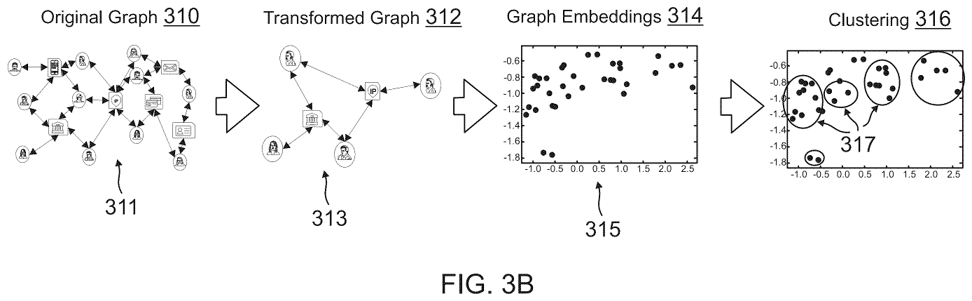

FIGS. 3A-3B are exemplary diagrams 300a and 300b of executable processes for generating and clustering graph embeddings from relationship graphs of linked account data, according to an embodiment. Diagrams 300a and 300b of FIGS. 3A and 3B include operations for converting relationship graphs 135 to graph embeddings 137 and clustering graph embeddings 137 to cluster 139 for training and inferencing with ML model 138, which may be executed by account clustering modeler 131 of fraud detection platform 130 for service provider system 120, discussed in reference to system 100 of FIG. 1. As such, diagrams 300a and 300b may represent the process for ML model training that may be performed when training and ML clustering model for inferencing with regard to account networks that may link accounts and their account data to fraudsters and fraudster accounts.

In diagram 300a of FIG. 3A, a process to generate a graph embedding for ML clustering and ML model training, is shown, such as a process that may convert the transformed graph in diagram 200c, such as a transformation of one of relationship graphs 135 to a transformed and size reduced graph having one or more of merged nodes 136, to one or more of graph embeddings 137. In this regard, a network 302 may represent a transformed and reduced account network in a relationship graph having nodes 304 connected by edges 306. Nodes 304 may include account and account data nodes, as well as merged nodes of multiple accounts and/or account data. For example, nodes 304 for accounts and/or account data may include those having soft connections and/or links to other accounts and/or account data, and as such, may not be merged by the graph transformation process. However, merged nodes represented in nodes 304 may include those that have hard connections and/or links such that the nodes have been merged based on an assumption of connectivity, relatedness, and/or common or group affiliation. Further, ones of edges 306 that remain connected to other accounts and/or account data based on soft connections may also be merged, as well as weighted based on the connections merged, their previous weights, and/or the number of merged connections. This process therefore reduces the size of the data and input of network 302 so that a reduced and/or minimal number of nodes 304 and edges 306 may be required for converting network 302 to graph embeddings 308 shown in diagram 300a.

In this regard, a graph embedding process and/or technique, such as LINE, may be applied to the data shown in network 302 including nodes 304 and edges 306. This process may vectorize and convert the data in network 302 to a mathematical representation of the data by encoding the states and/or information of nodes 304 and/or edges 306 into discreet values that may be combined in an element, set, quantity, number, coordinates or coordinate values, or other mathematical representation having a number of dimensions, n, that may correspond to the input features and/or data. As such, graph embeddings 308 may represent network 302 in a vector space as a vector (e.g., the embedding of the data), and may allow for clustering and/or other comparisons to other graphs and their vectors (e.g., their embeddings).

In diagram 300b, the end-to-end process for ML clustering and ML model training based on an original graph 310 is shown. Initially, original graph 310 of an account network 311 is shown having nodes for accounts and account data linked by edges representing connections from relationships between the accounts and account data. Original graph 310 may be converted or transformed to a transformed graph 312 where a reduced account network 313 having merged data nodes and connections may be utilized for a graph embedding process. Graph embeddings 314 may be generated from the merged nodes and their corresponding data, including the edges that have been merged and represent soft connections to other accounts and/or account data.

In this regard, graph embeddings 314 may be represented in a vector space 315 that allows for a clustering 316 to be performed using an ML clustering algorithm. In some embodiments, clustering 316 may be performed using HDBSCAN, or may another supervised or unsupervised ML clustering algorithm may be used. In some embodiments, selection of the algorithm may be performed based on a cluster parameter, a cluster stability, or a performance metric. As such, clustering 316 may apply an ML clustering algorithm to graph embeddings 314 in vector space 315 to determine clusters 317 based on hyperparameters for cluster selection, size, membership, centroid, or the like. After clustering 316 is performed, clusters 317 may be determined and used for ML training and inferencing. For example, clusters 317 may be established with an ML clustering model that may be trained and configured using the ML clustering algorithm to generate an embedding, vector, or the like from input data and compare the input data using the converted embedding, vector, or the like to the clusters.

In this regard, clusters 317 from clustering 316 may be used for various inferencing and/or predictive outputs, such as fraud detection, risk assessments, and the like, As such, clusters 317 may be implemented in a risk and/or fraud detection system and ML model so that other accounts having similar soft connections to the same or similar account data may be identified, and as such, when those account match or are correlated to one of clusters 317 having fraudulent accounts, fraud may be identified or predicted. However, clusters 317 may be utilized for other purposes as well when identifying similar accounts. For example, an ML model may utilize clusters 317 for advertising, upselling, and/or outreach based on the same or similar behaviors, interests, or histories (e.g., transaction histories or past purchases) of those accounts. Clusters 317 may also be applied to provide predictive account services based on account lifecycles and uses by accounts in clusters 317. In other embodiments where accounts may instead correspond to users, other inferences and correlations may be made between users in the same clusters and/or when correlated to one of clusters 317, such as interests of the users, behaviors, and the like.

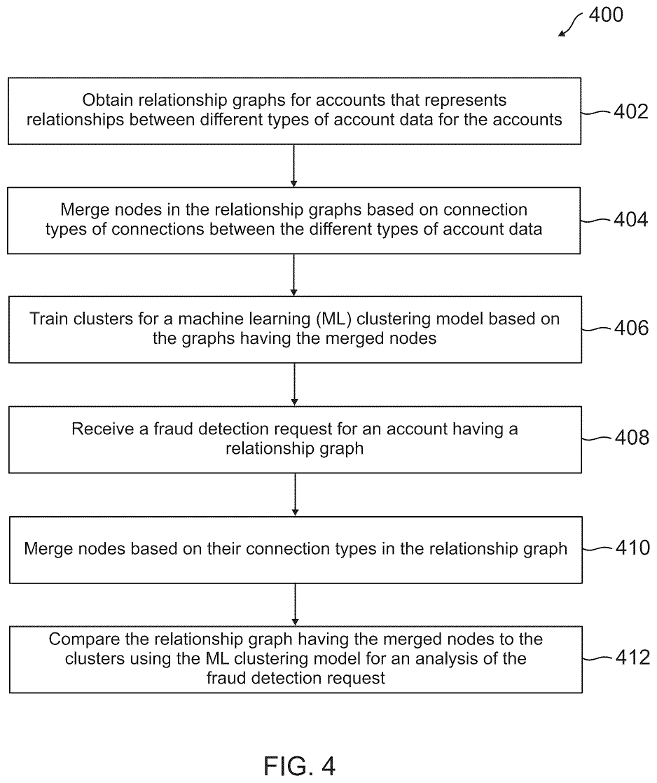

FIG. 4 is a flowchart 400 for fraud detection and data correlations through large-scale graph clustering of graph transformations and embeddings, according to an embodiment. Note that one or more steps, processes, and methods described herein of flowchart 400 may be omitted, performed in a different sequence, or combined as desired or appropriate.

At step 402 of flowchart 400, relationship graphs for accounts that represents relationships between different types of account data for the accounts are obtained. Relationship graphs 135 may be accessed from a database and/or determined using account data 132 based on relationships 133 including activities 134. In this regard, relationship graphs 135 may correspond to account networks of accounts and their corresponding account data that has been associated with the account, for example, through uses, interactions, activities, and the like. However, relationship graphs 135 may have a large number of nodes and edges, thereby causing embedding of the data, such as encoding the nodes and/or edges into vectors through an embedding process, may result in complex and high dimensionality vectors/embeddings, which are difficult to handle and cluster. As such, the service provider handling relationship graphs 135 may then convert such graphs to transformed graphs through a graph transformation process to generate merged nodes 136 and create graph embeddings 137 from the transformed graphs.

At step 404, nodes in the relationship graphs are merged based on connection types of connections between the different types of account data. Relationship graphs 135 may be parsed and/or analyzed to determine the nodes and their corresponding data, as well as the edges representing the connections for relationships 133 between the corresponding data for the nodes. As such, each node may be associated with a particular account or individual portion/datum from account data for the account and may be connected to other accounts and/or account data based on relationships 133 for their previous uses, interactions, activities, or other manner in which the accounts and/or account data is connected.

Further, each of the connections between the nodes may have a corresponding connection type. A connection type may be assigned to two nodes or objects and may identify the type of account data linked to the account and/or other account data, and therefore may signify a “hard” or “soft” link between the two nodes. For example, an account linked to certain account data in a first set of types of account data may have their connections be assigned a “hard” connection type, while a second set of types of account data may have their connections be assigned a “soft” connection type. These connection types may be used for node merging. Furthermore, other degrees of links and correlations may also be used aside from “hard” or “soft”, or two binary classifications. For example, a medium link and/or connection type may also be associated with different types of

A graph transformation process may then merge nodes based on their connection type between each other. For example, all of the nodes connected via an edge having been assigned the connection type of “hard connection” may be merged into a single node now representing that set of nodes connected via hard connections. However, if the nodes are connected by “soft connections,” those nodes may not be merged and as a result, a set of merged nodes 136 may be generated. Instead, the edges for the soft connections may be merged and weighted based on the number merged and/or weights of those initial edges. Once relationship graphs 135 have been transformed, graph embeddings 137 may be used to generate embeddings of the transformed graphs using a graph embedding process or technique, such as LINE.

At step 406, clusters for an ML clustering model are trained based on the graphs having the merged nodes. Clusters 139 may be generated for training of ML model 138 for cluster-based inferencing and/or predicting, such as generating outputs intended to classify and/or predict whether accounts are fraudulent or acting fraudulently based on their relationship graphs and connections with other accounts. In this regard, clusters 139 may be generated using an ML clustering algorithm and/or process, such as HDBSCAN or other technique that may utilize an ML clustering algorithm to cluster vectors of embeddings in a vector space. The clustering algorithm may generate clusters 139 having cluster parameters or attributes, such as a centroid, size, distance from centroid, membership, and the like, and each of clusters 139 may be associated with metadata and/or account annotations or flags that indicate shared or common behaviors, attributes, activities, or the like for the members of the corresponding cluster, such as if that cluster is associated with fraudulent accounts having links to other fraudulent accounts and/or account data. As such, graph embeddings 137 allow for more efficient, faster, and more accurate training of ML models without relying on complete and high dimensional embeddings or other vectors.

At step 408, a fraud detection request for an account having a relationship graph is received. Once ML model 138 is trained, it may be deployed with one or more fraud detection systems, which may be configured to be utilized with service applications 122 to handle fraud detection requests 123. Fraud detection requests 123 may be received during the use of service applications 122, such as when a user may engage in electronic transaction processing or other usage of an account to perform an online interaction or utilize a computing service. As such, ML model 138 may handle fraud detection requests 123 by determining a relationship graph for the account associated with the request.

At step 410, nodes are merged based on their connection types in the relationship graph. In a similar manner to the operations for graph transformations used during training of ML models 138, such as when generating merged nodes 136 usable for creating transformed graphs of relationship graphs 135 and, by extension, graph embeddings 137, a graph transformation process may be applied to the relationship graphs received and/or determined in association with fraud detection requests 123. The relationship graph may be parsed, and hard linked account data and soft linked account data may be determined for different nodes based on their connection type and corresponding data for the nodes to the connections. Those nodes with hard connection type links may be merged, which may create a set of merged nodes, while the edges having soft connection type links may be merged after merging the hard linked nodes to create a new account network or other representation of relationships. This allows for determination of a condensed version of the data for the relationship graph, and more efficient inferencing.

At step 412, the relationship graph having the merged nodes is compared to the clusters using the clustering ML model for an analysis of the fraud detection request. ML model 138 may utilize clusters 139 with a ML clustering algorithm or technique to associate the graph embedding of the relationship graph for the account to one of clusters 139. Once associated, ML model 138 may provide an inference, such as a risk or fraud score, which may indicate the likelihood that an account is fraudulent or associated with fraudulent activity and/or actors/accounts. This score may be compared to a threshold, which allows for automated decisioning on whether to execute a fraud prevention action, such as blocking a transaction, notifying a user, banning or blacklisting an account, or the like, or whether the activity may be permitted.

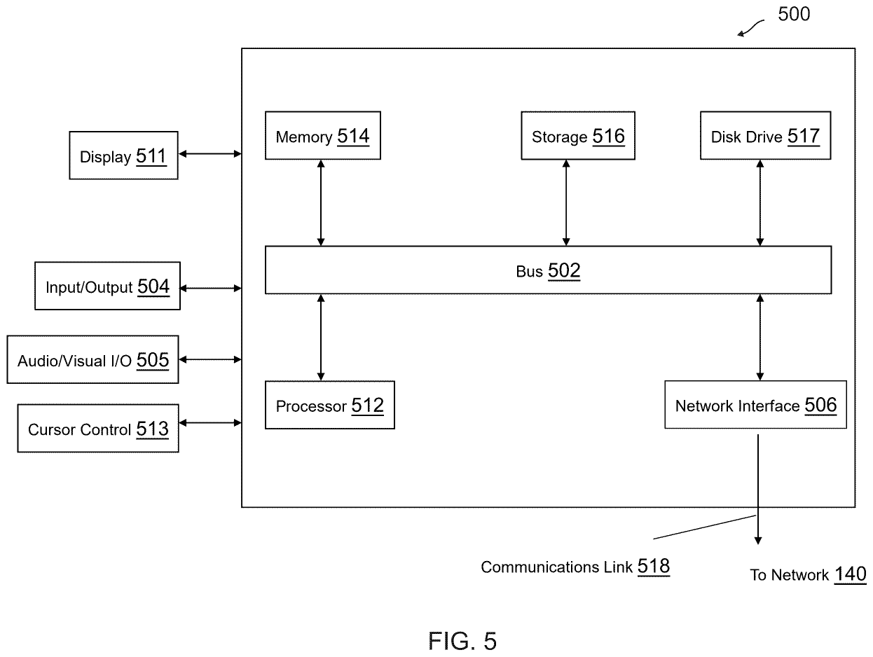

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, images, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output (I/O) component 505 may also be included to allow a user to use voice for inputting information by converting audio signals and/or input or record images/videos by capturing visual data of scenes having objects. Audio/visual I/O component 505 may allow the user to hear audio and view images/video including projections of such images/video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory storing instructions; and
one or more hardware processors coupled to the non-transitory memory and configured to read the instructions from the non-transitory memory to cause the service provider system to perform operations comprising:
receiving a training data set comprising a plurality of relationship graphs each representing an account network of a corresponding account, wherein the account network comprises account data and relationships between types of the account data, and wherein each node in the plurality of relationship graphs corresponds to one of the types and each edge represents one of the relationships;
determining whether each edge in the plurality of relationship graphs is a first connection type or a second connection type between corresponding nodes of the plurality of relationship graphs;
merging each node in the plurality of relationship graphs that are associated with the first connection type;
transforming each of the plurality of relationship graphs into a plurality of transformed graphs based on the merging, wherein the transforming includes merging each edge for the second connection type that are connected to merged nodes resulting from the merging without further merging the corresponding nodes for the second connection type;
training a machine learning (ML) clustering model based on the plurality of transformed graphs; and
executing an action with a new account based on comparing new account data for the new account to a plurality of clusters of the plurality of transformed graphs using ML clustering model.

2. The service provider system of claim 1, wherein an ML engine utilizes an unsupervised ML clustering algorithm for the ML clustering model, and wherein the unsupervised ML clustering algorithm is selected based on at least one of a cluster parameter, a cluster stability, or a performance metric.

3. The service provider system of claim 1, wherein the first connection type comprises hard linked account data including at least one of contact information, a financial account number, or a user identity number, and wherein the second connection type comprises soft linked account data including at least one of a virtual identifier, a device identifier, or a domain identifier associated with the contact information or the financial account number.

4. The service provider system of claim 3, wherein merging each node comprises merging the hard linked account data into the merged nodes that represent subsets of the hard linked account data, and wherein the merging each edge comprises merging soft links between subsets of the soft linked account data based on the subsets of the hard linked account data in the merged nodes.

5. The service provider system of claim 1, wherein the transforming further includes:
weighting each merged edge for the second connection type based on at least one of a number of edges merged for each merged edge or a weight of the edges merged for each merged edge.

6. The service provider system of claim 5, wherein the transforming reduces a size of each of the plurality of relationship graphs based on the merging and the weighting, and wherein an accuracy of the ML clustering model is analyzed based on the plurality of transformed graphs and the plurality of relationship graphs prior to reducing the size.

7. The service provider system of claim 1, wherein the training the ML clustering model comprises:
generating a plurality of embeddings of the plurality of transformed graphs;
performing an ML clustering of the plurality of embeddings using an ML clustering technique; and
generating the plurality of clusters based on the performing the ML clustering.

8. The service provider system of claim 7, wherein the plurality of embeddings are generated using a graph embedding that represents each node in the plurality of transformed graphs with a vector.

9. The service provider system of claim 1, wherein the operations further comprise:
receiving the new account data; and
generating a risk assessment of the new account data using the ML clustering model and one or more attributes associated with one of the plurality of clusters that meet or exceed a threshold similarity to the new account data.

10. A method comprising:
receiving a fraud detection request associated with an account having account data, wherein the account data includes different types of the account data linked by relationships between the different types;
generating a first relationship graph representing the account based on the account data, wherein nodes of the first relationship graph represent the different types of the account data and edges represent the relationships between the different types;
merging a first set of the nodes linked by a first connection type of the edges;
merging two or more of the edges for a second set of the nodes linked by a second connection type of the edges;
transforming the first relationship graph to a second relationship graph based on the merging the first set of the nodes and the two or more of the edges;
comparing the second relationship graph to a plurality of relationship graphs using an ML clustering model, wherein the comparing is performed by the ML clustering model using a plurality of clusters generated from embeddings of the plurality of relationship graphs; and
determining a response for the fraud detection request based on the comparing, wherein the response is associated with account behaviors of at least one of the plurality of clusters within a threshold similarity to the second relationship graph.

11. The method of claim 10, wherein, prior to the generating the first relationship graph, the method further comprises:
training the ML clustering model using the plurality of clusters.

12. The method of claim 11, further comprising:
generating the plurality of embeddings using a graph embedding technique.

13. The method of claim 12, further comprising:
clustering the plurality of embeddings using an ML clustering algorithm.

14. The method of claim 13, wherein the graph embedding process comprises Large-scale Information Network Embedding (LINE), and wherein the ML clustering algorithm comprises Hierarchical Density-Based Spatial Clustering of Applications with Noise (HDBSCAN).

15. The method of claim 10, wherein the first relationship graph comprises an account network identifying the account data that has been associated with the account and different ones of the account data from at least one of previous uses of the account or previous interactions by the account.

16. The method of claim 10, wherein the first relationship graph comprises a non-transformed graph having the nodes and the edges in an account network, and wherein the second relationship graph comprises a transformed graph having a condensed version of the account network after the transforming.

17. A non-transitory machine-readable medium having stored thereon machine-readable instructions executable to cause a machine to perform operations comprising:
accessing a plurality of relationship graphs for a plurality of accounts, wherein the plurality of relationship graphs include a plurality of nodes and a plurality of edges, wherein each node of the plurality of nodes corresponds to one of an account or account data associated with the account, and wherein each of the plurality of edges correspond to one of two connection types between the account and the account data based on types of the account data linked to the account;
merging two or more nodes of the plurality of nodes in the plurality of relationship graphs that are associated with a first one of the two connection types, wherein the two or more nodes are linked by one or more of the plurality of edges having the first one of the two connection types based on the type of the account data for at least one of the two or more nodes;
merging two or more edges of the plurality of edges in the plurality of relationship graphs that have a second one of the two connection types;
transforming the plurality of relationship graphs into a plurality of transformed graphs based on the merging the two or more nodes and the two or more edges;
training a machine learning (ML) clustering model based on the plurality of transformed graphs; and
performing an inferencing of a fraudulent account using the ML clustering model and based on a relationship graph for the fraudulent account.

18. The non-transitory machine-readable medium of claim 17, wherein the two connection types comprise first linked account data to the account or second linked account data to the account, wherein the first linked account data is associated with a first set of the types of the account data and wherein the second linked account data is associated with a second set of the types of the account data.

19. The non-transitory machine-readable medium of claim 17, wherein, prior to the training the ML clustering model, the operations further comprise:
generating a plurality of graph embeddings from the plurality of transformed graphs using a graph embedding process; and
clustering the plurality of graph embeddings into a plurality of clusters using an ML clustering algorithm associated with the ML clustering model,
wherein the ML clustering model is trained using the plurality of clusters.

20. The non-transitory machine-readable medium of claim 19, wherein the graph embedding process comprises Large-scale Information Network Embedding (LINE), and wherein the ML clustering algorithm comprises Hierarchical Density-Based Spatial Clustering of Applications with Noise (HDBSCAN).
